(19) United States
(12) Patent Application Publication
(10) Pub. No.: US 2016/0361236 A1
(43) Pub. Date: Dec. 15, 2016

(54) NASOGASTRIC TUBE INTRODUCER DEVICE

(71) Applicant: National University of Singapore, Singapore (SG)

(72) Inventors: Wan'E LIM, Singapore (SG); Kwan-Ho Casey CHAN, Singapore (SG); Kok Meng SUM, Singapore (SG); Wanpei CAI, Singapore (SG); Anurag Dilip SHARMA, Singapore (SG); Yu Ling TAY, Singapore (SG); Kai HUANG, Singapore (SG); Nader HAMZAVI, Singapore (SG)

(73) Assignee: National University of Singapore, Singapore (SG)

(21) Appl. No.: 15/178,097

(22) Filed: Jun. 9, 2016

Related U.S. Application Data
(60) Provisional application No. 62/172,876, filed on Jun. 9, 2015.

(51) Int. Cl. A61J 15/00

(52) U.S. Cl. CPC A61J 15/0084; A61J 15/0003; A61J 15/0088

(57) ABSTRACT

We describe a nasogastric tube introducer device to assist medical practitioners and others in the medical field with the insertion of a nasogastric tube (NGT) to facilitate feeding and/or administration of oral medications to patients in need thereof.

### FIELD OF THE INVENTION

This invention generally relates to a device to assist medical practitioners and others in the medical field with the insertion of a nasogastric tube (NGT) to facilitate feeding and administration of oral medications to patients in need thereof.

### BACKGROUND TO THE INVENTION

The listing or discussion of an apparently prior-published document in this specification should not necessarily be taken as an acknowledgement that the document is part of the state of the art or is common general knowledge.

Nasogastric tubes (NGTs) are used for feeding and administering oral medication in patients with either impaired swallowing mechanisms or obstruction in the upper aerodigestive tract that prevents oral feeding. They are inserted through the nose into the stomach and represent an important means of long-term feeding especially in patients with neurological diseases (e.g. strokes). The procedure to insert an NGT is minimally invasive, effective and can be performed by trained personnel such as nurses and doctors.

Inserted tubes can coil in the pharynx or loop back up into the distal esophagus from the stomach. A misdirected NGT may result in aspiration pneumonia and even death. Reported rates of tube misplacement on insertion and to migration after correct initial placement vary in the literature between 1.3% and 50% in adults [de Aguilar-Nascimento, J. E. and K. A. Kudsk, Curr Opin Clin Nutr Metab Care 10(3): 291-6 (2007)]. For blind insertion, rates of respiratory placement between 1 and 3% are commonly reported [Benya, R., Langer, S. and Mobarhan, S. JPEN J Parenter Enteral Nutr 14(1): 108-9 (1990)]. NGT placement entails a significant risk of malpositioning that may result in lung puncture or death from aspiration of liquids into the lungs and expose healthcare institutions to significant medicolegal liability risks. One death is enough to cause substantial damage to a hospital's reputation. Although NGT placement is a simple procedure it accounted for one death every 3 months in a tertiary hospital [de Aguilar-Nascimento, J. E. & Kudsk, K. A. JPEN J Parenter Enteral Nutr 31: 269-273 (2007)] and 3600 deaths each year in the US [Krenitsky, J. Practical Gastroenterology 93: 11 (2011)]. Trained personnel such as nurses and doctors are required to perform the insertion. Currently, there are 3 methods to verify tube placement.
1. The pH of fluid aspirated from the NGT—acidic pH confirms gastric placement.
2. Auscultation of air injected into NGT—detection of a “whoosh” sound confirms gastric placement.
3. Chest x-rays can be used to confirm placement.

Yet, current methods of confirming correct placement are not fool proof because they do not confirm the exact site of tube placement. The pH method is inaccurate, and the auscultation method is unreliable in determining the tube placement; whereas x-rays entail a delay in confirmation, constitute an additional test, are prone to misinterpretation and involve radiation exposure [Metheny, N. A., Meert, K. L. & Clouse, R. E. Curr Opin Gastroenterol 23: 178-182 (2007)].

While the above methods provide information on location none of them actually actively guide NGT placement in the correct location. While established methods of NGT placement confirmation are unreliable, the alternatives such as electromagnetic or endoscopic guided confirmations are costly and technologically more complex.ln the US, 1.2 million NGT's are inserted yearly. The National Patient Safety Agency (NPSA) estimates that at least 1 million tubes are purchased every year in England and Wales [Coombes, R., Brit Med J 330(7489): 438 (2005)]. NGTs in terms of revenue share and its global market was valued at USD 196.6 million in 2013 [www.grandviewresearch.com/industry-analysisienteral-feeding-devices-industry]. Europe held the largest share of the market in 2013 at 35.0%. The presence of a large geriatric population base in the Western European region, escalating healthcare costs are some of the major drivers of this market. The Asia-Pacific enteral feeding devices market expected to grow at the fastest CAGR of 6.7% from 2014 to 2020 owing to drivers such as the presence of high unmet medical needs in emerging markets with constantly improving healthcare infrastructure and healthcare expenditures such as India and China.

There is a need for efficiently and sensitively guiding NGTs into the stomach of a patient whilst avoiding misalignments into the lung. This need can be broken down into 3 sub-requirements:
1. The need for better steerability to increase the chance of getting the NGT directly into the esophagus with minimal attempts.
2. The need for reliable confirmation that is superior to the methods described above.
3. The need to reduce procedural morbidity and mortality.

This invention aims to reduce the complications arising from misplaced, coiled and/or looped tubes. The present invention provides a simple, cost- and time-effective solution for both patients and professionals alike.

### SUMMARY OF THE INVENTION

Embodiments described herein may therefore allow for efficiently and sensitively positioning the distal end of the nasogastric tube introducer device with minimal discomfort and/or mucosal injury while avoiding cannulation of the trachea.

In one aspect of the invention there is provided a nasogastric tube introducer device comprising guide means in order to guide the nasogastric tube into a subject, the guide means comprising a semi-rigid longitudinal conduit having a peripheral wall defining a passageway therethrough extending from a first/proximal end to a second/distal end, wherein the conduit is curvilinear comprising a curvature that conforms to the anatomy of the nasopharynx area and wherein the curvature improves steering of the nasogastric tube towards the gastrointestinal tract, wherein the second/distal end is curved with a posterior bias to reduce the likelihood of cannulation of the trachea, wherein the conduit has a handle at the first end and wherein the conduit comprises a longitudinal slit defined in the peripheral wall of the conduit to enable the conduit to be split and separated from the nasogastric tube, leaving the nasogastric tube in place.

In a preferred embodiment of the invention the conduit has an elliptical cross-sectional profile to more closely conform to the anatomical shape of the opening of the esophagus.

In another preferred embodiment of the invention the semi-rigid material is silicone.

In another aspect of the invention, the nasogastric tube introducer device further comprises an alarm member mounted thereto at the first/proximal end that detects air passing through the trachea and provides an indication whether the nasogastric tube introducer is correctly positioned in the gastrointestinal tract or is misplaced in the lung of said subject

In a preferred embodiment of the invention, the alarm member is whistle-like and produces a distinct sound corresponding to the bidirectional airflow in the trachea of the subject; wherein an audible signal indicates tracheal cannulation and correct placement in the esophagus does not produce the audible signal.

In another preferred embodiment of the invention the tip of the second/distal end is comprised of a compliant material to prevent mucosal injury.

In another preferred embodiment of the invention, the tip of the second/distal end is bevelled.

In another preferred embodiment of the invention, the tip of the second/distal end is comprised of silicone.

In another preferred embodiment of the invention, the longitudinal slit comprises a tear-away slit.

In another preferred embodiment of the invention, the conduit comprises guide and depth markings.

In another preferred embodiment of the invention, the conduit is configured so that its distal end is advanced to its position of intended use in the hypopharynx just above the cricopharyngeus muscle and eventually passes through the cricopharyngeus muscle into the esophagus (which is the end destination of the introducer).

In another preferred embodiment of the invention, the nasogastric tube introducer device is manufactured from silicone and the conduit has an elliptical cross-sectional profile, has a bevelled tip at the distal end comprised of a compliant material to prevent mucosal injury and comprises a tear-away slit.

In another preferred embodiment of the invention the device is made from silicone and the silicone for the guide means is MED-4080 HCR (high consistency rubber) or the equivalent thereof; the silicone for the distal tip is MED-4930 or the equivalent thereof; the silicone for the handle is MED-4950 LSR (liquid silicone rubber) or the equivalent thereof; the inner surface is coated with silicone MED-6670 or the equivalent thereof and the outer surface is coated with MED 6670/Parylene or the equivalent thereof.

Another aspect of the invention provides use of the nasogastric tube introducer device according to any aspect of the invention to insert a nasogastric tube through the nose and into the stomach of a patient.

### BRIEF DESCRIPTION OF THE DRAWINGS

These and other aspects of the invention will now be further described, by way of example only, with reference to the accompanying figures, wherein like numerals refer to like parts throughout, and in which:

FIG. 1 shows an example of a nasogastric tube introducer device according to embodiments of the present invention;

FIG. 2 shows another example of a nasogastric tube introducer device according to embodiments of the present invention;

FIG. 3 shows another example of a nasogastric tube introducer device according to embodiments of the present invention;

FIG. 4 shows a manufactured example of a nasogastric tube introducer device according to embodiments of the present invention;

FIGS. 5A, 5B and 5C show examples of 3D-printed nasogastric tube introducer devices in three different sizes, CH10, CH12 CH14, respectively; either with curvature A or B, tested on manikins;

FIG. 6A shows a size CH12 3D-printed nasogastric tube introducer device with curve A successfully inserted into the esophagus on a manikin (Gaumard Hal S3201);

FIG. 6B shows a 3D-printed nasogastric tube introducer device according to embodiments of the present invention in situ in the esophagus of a manikin (Gaumard Hal S3201);

FIG. 7 shows a size CH12 3D-printed nasogastric tube introducer device with curve A was successfully inserted into the esophagus of a cadaver;

FIGS. 8A and 8B show technical specification of extruded nasogastric tube introducer device made from silicone (MED-4080 HCR; NuSil Technology LLC, CA 93013 USA) according to embodiments of the present invention. Dimensions are in inches.

FIGS. 9A, 9B and 9C show technical drawings of extruded nasogastric tube introducer device made from silicone and coated inside and out with NUSIL MED-6670 according to embodiments of the present invention. FIG. 9A shows side view of device whereby guide is made of NUSIL MED-4080; soft bevel tip is made of NUSIL MED-4930 and handle is made of NUSIL MED-4950. FIG. 9B shows cross-section through plane A-A. FIG. 9C shows front view of handle at proximal end of the guide. Dimensions are in millimeters;

FIGS. 10A, 10B, 10C and 10D show technical drawings of extruded nasogastric tube introducer device handle made from NUSIL MED-4950 according to embodiments of the present invention. Dimensions are in inches;

FIGS. 11A, 11B and 11C show technical drawings of extruded nasogastric tube introducer device soft beveled tip made from NUSIL MED-4930 according to embodiments of the present invention. Dimensions are in inches.

### DESCRIPTION OF PREFERRED EMBODIMENTS

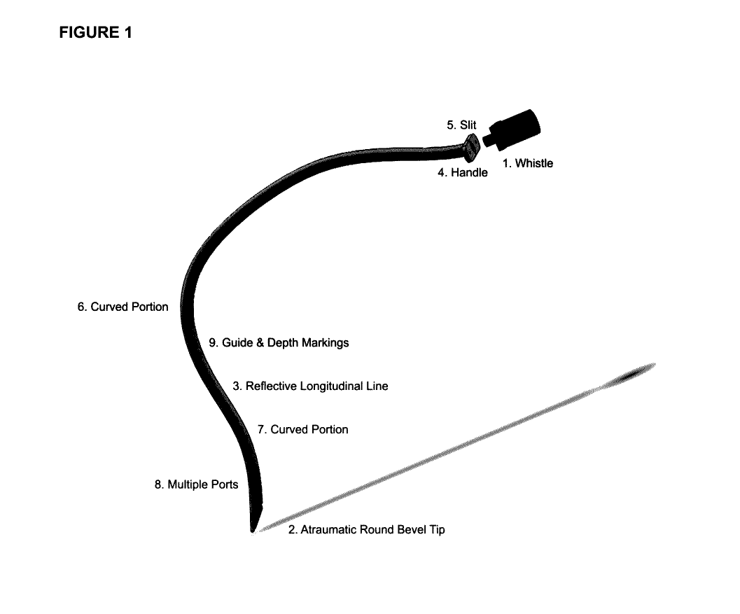

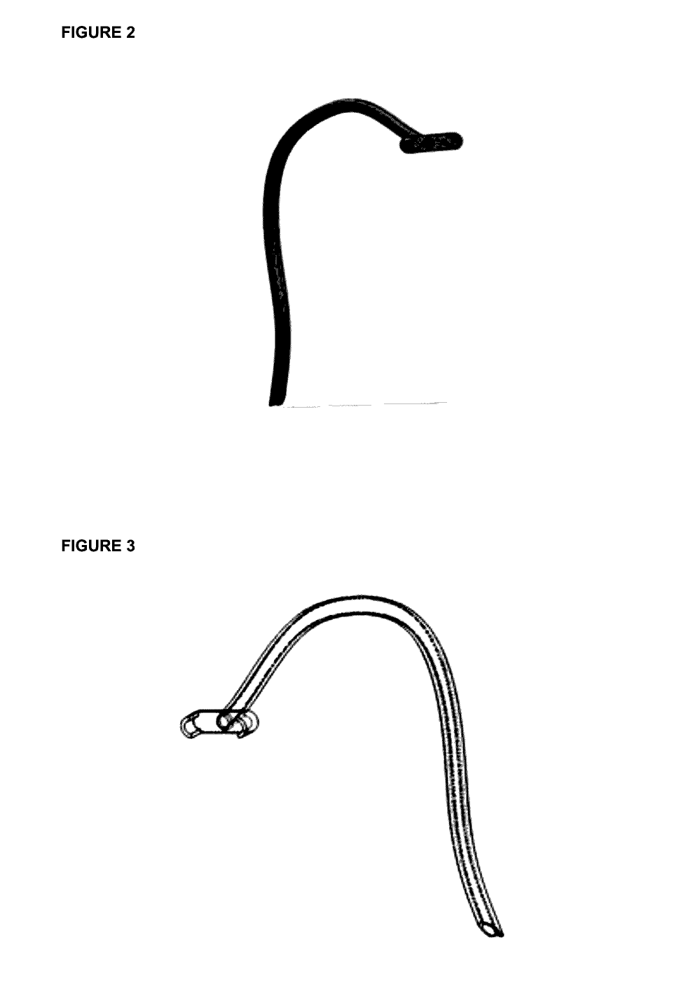

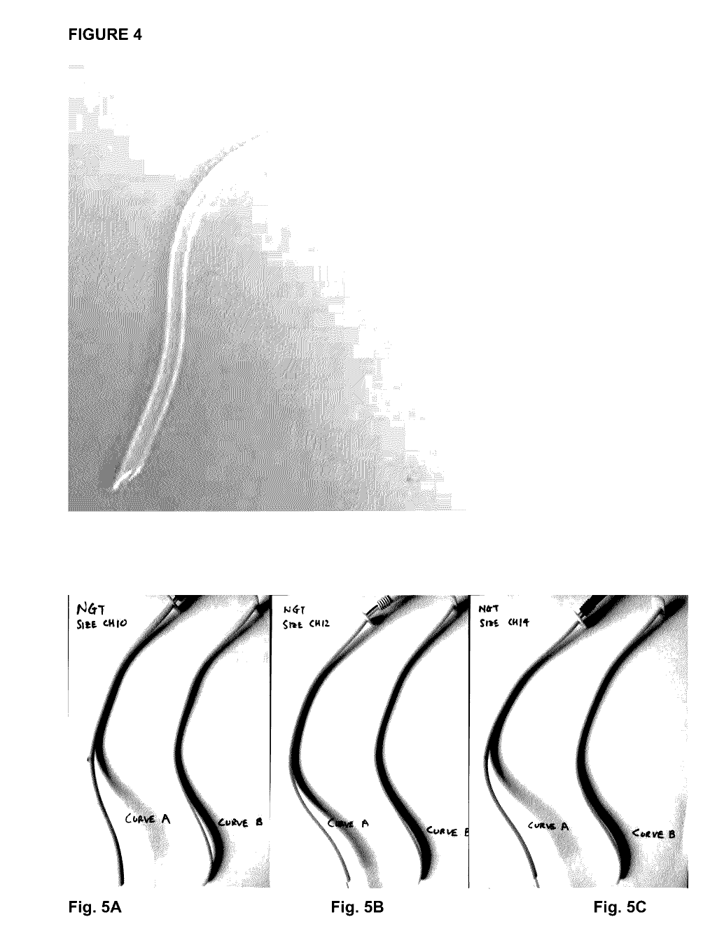

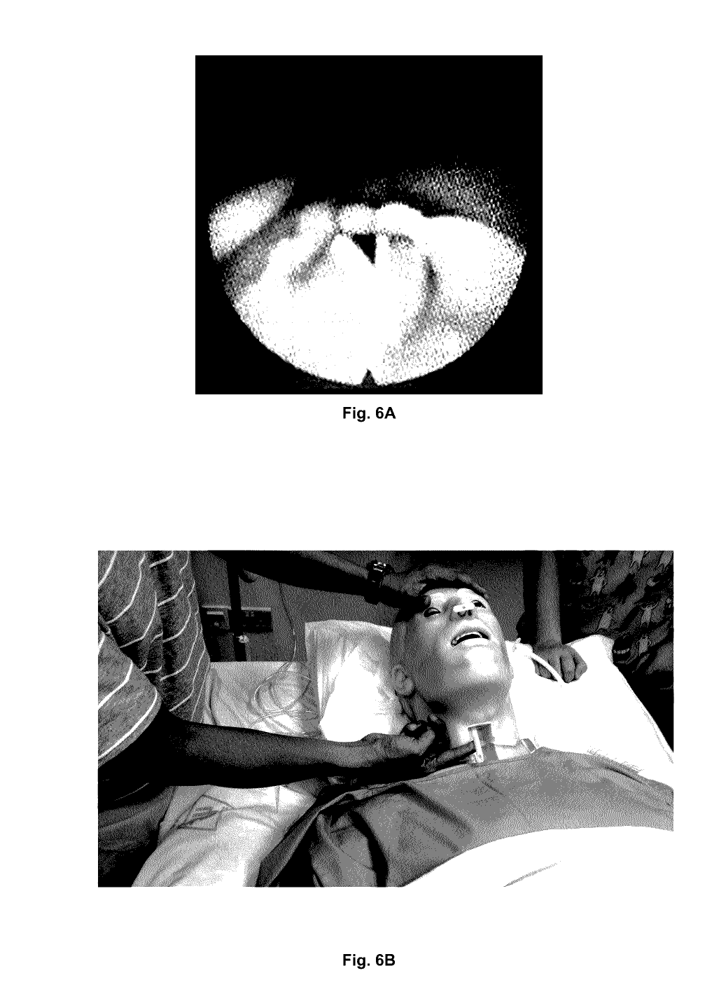

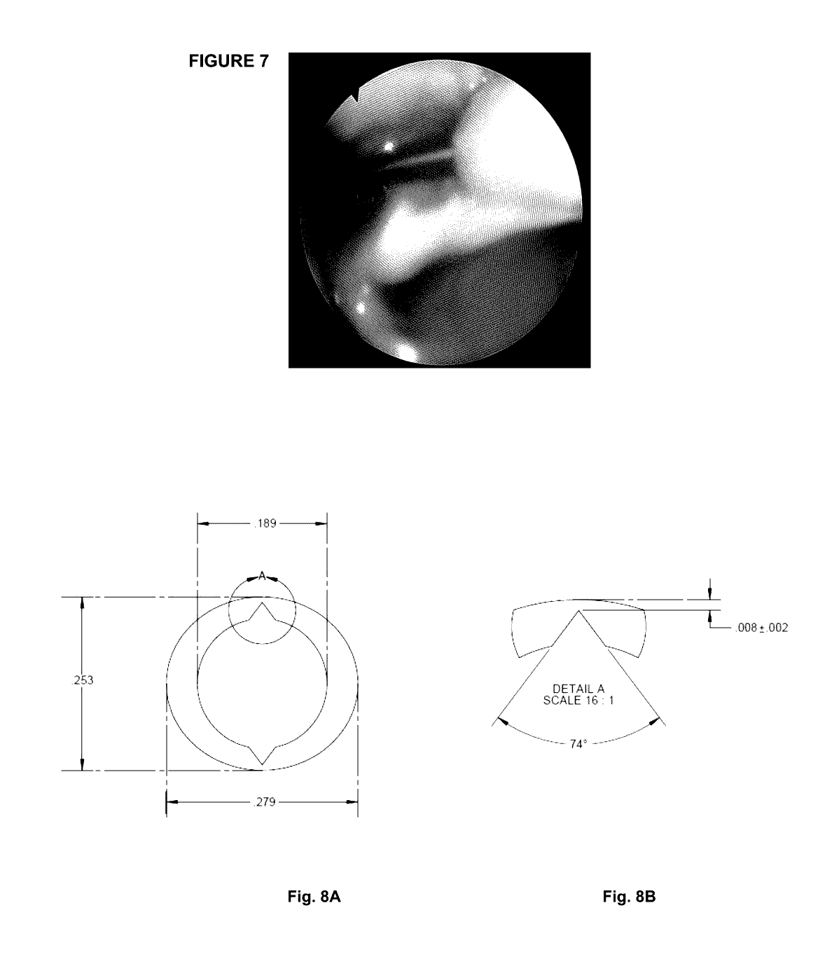

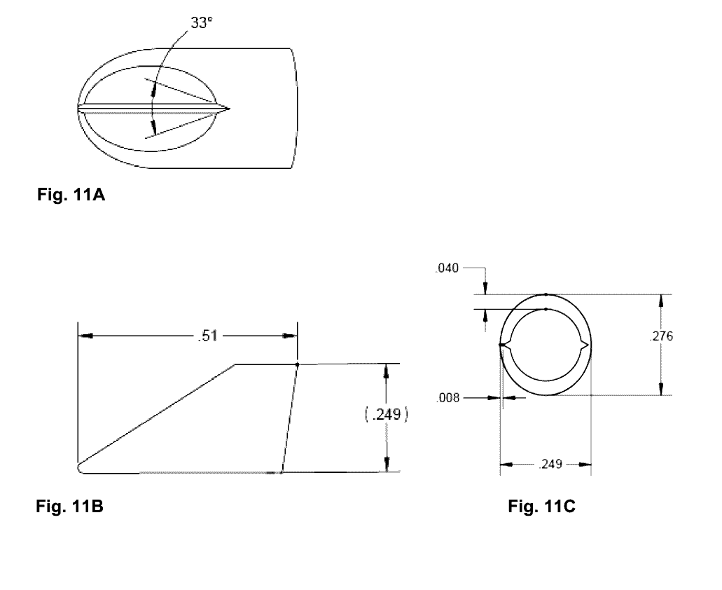

We describe a novel nasogastric tube introducer device (FIGS. 1, 2, 3, 4, 8A, 8B, 9A, 9B, 9C, 10A, 10B, 10C, 10D, 11A, 11B and 11C) comprising guide means in order to guide the nasogastric tube into a subject, the guide means comprising a longitudinal hollow conduit having a peripheral wall defining a passageway therethrough extending from a first/proximal end to a second/distal end. When used, the second/distal end of the device is inserted into the nasal cavity of a patient and the first/proximal end remains outside the nose. The device is manoeuvred as it is inserted in order for the distal end to locate in the gastrointestinal tract. A nasogastric tube can then be relatively easily passed through the conduit to the stomach.

Preferably the conduit is curvilinear comprising a unique “S” shaped curvature (see for example, FIGS. 1, 2, 3, 4 #6; 9A) that conforms to the anatomy of the nasopharynx area, the design being based on nasal passage profiles from patient CT scans. The curvature improves steering of the nasogastric tube towards the gastrointestinal tract. The shape of the device generates gentle torque that guides the insertion to land in the hypopharynx in optimal position for esophageal cannulation, giving the device a predictable landing zone in the esophagus. Preferably the conduit has a posteriorly directed second/distal end (FIGS. 1 #7, 9A). Such a curvature further assists to guide the nasogastric tube away from the trachea towards the esophagus which is posterior to the larynx and reduces the chance of tracheal cannulation. A combination of the anatomically conforming curvilinear form and semi-rigid but flexible material reduces the likelihood of multiple nasogastric tube insertion attempts and results in a procedure that is less time-consuming than when x-rays are used for monitoring positioning.

In a preferred embodiment, the nasogastric tube introducer device further comprises an alarm member mounted at the first/proximal end. The alarm member may be detachably mounted. In view of hygiene concerns, a disposable alarm would be favoured.

In order to be more certain that the device is not misaligned in the trachea, the alarm member is attached to the first/proximal end of the device and works on the basis of air passing through the trachea to provide an indication whether the nasogastric tube is correctly positioned in the gastrointestinal tract or is misplaced in the lung of said subject. The auditory feedback mechanism produces a characteristic warning sound should cannulation of the trachea occur. This sound is not produced if the esophagus is successfully cannulated. An example of a suitable alarm is the disposable BAAM® Beck Airway Airflow Monitor device (Great Plains Ballistics, Lubbock, Tex., USA).

The conduit preferably has a posteriorly directed round bevelled tip at the second/distal end (FIGS. 1 #2; 9A, 9B, 9C; 11A, 11B). Bevelling the tip improves air flow through the conduit for more effective triggering of the alarm member.

The skilled person will appreciate that there may be several ways in which a nasogastric tube introducer device can be manufactured. One suitable method is by the use of 3D printing; another is by extrusion. In a preferred embodiment of the invention, the nasogastric tube introducer device is comprised of a semi-rigid material and may have an elliptical cross-sectional profile. An elliptical profile provides an advantage because it more closely matches the elliptical shape of the inlet to the esophagus.

It may be made of any suitable medical grade material such as plastic, polymers, latex, silicon or the like. Preferably the device is engineered in a moderately stiff yet flexible silicone which confers steerability and a predictable landing at the desired target zone without overt discomfort to the patient. An example of a suitable silicone is NUSIL MED-4080 HCR (NuSil Technology LLC, CA 93013 USA). The last two digits refer to the silicone hardness (Durometer, Type A 80, ASTM D2240).

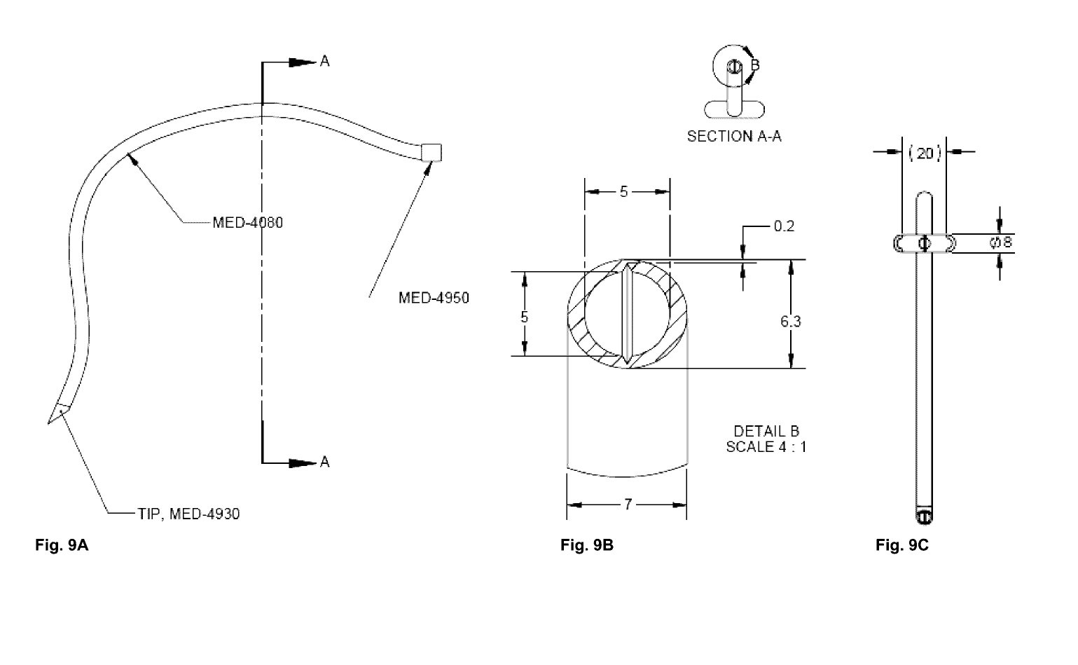

The tip of the posteriorly curved second/distal end (FIGS. 9A; 11A and 11B) is preferably comprised of a softer more compliant material to prevent mucosal injury. The compliant material may be silicone and an example of a suitable silicone is NUSIL MED-4930 (NuSil Technology LLC, CA 93013 USA). The last two digits refer to the silicone hardness (Durometer, Type A 30, ASTM D2240).

In a preferred embodiment, the nasogastric tube introducer device is coated on the inner (luminal) surface with a coating that reduces friction and can tolerate sterilization. An example of a suitable coating is NUSIL MED-6670 (NuSil Technology LLC, CA 93013 USA). The last two digits refer to the silicone hardness (Durometer, Type A 70, ASTM D2240). Preferably, the outer surface of the nasogastric tube introducer device is coated with a substance that reduces friction and can tolerate sterilization. An example of a suitable coating is a combination of NUSIL MED-6670 (NuSil Technology LLC, CA 93013 USA) and Parylene (Parylene Coatings Services, Inc, Tex. 77494 USA).

The alarm member may be composed of various suitable compounds, such as plastic and/or polymers and could be complex or simple in operation and readout. A simple version of the alarm member is whistle-like (FIG. 1; #1), such as the disposable BAAM® Beck Airway Airflow Monitor device (Great Plains Ballistics, Lubbock, Tex., USA). A more complex alarm may be digital. The alarm may produce a distinct sound corresponding to the bidirectional airflow in the trachea of the subject; wherein an audible signal indicates tracheal cannulation.

The conduit preferably has a handle located at or near the first end (FIGS. 1 #4; 9C; 10A, 10B, 10C and 10D). The ergonomic handle provides the user with more control over the device during insertion and positioning and prevents the proximal end from entering the nasal cavity.

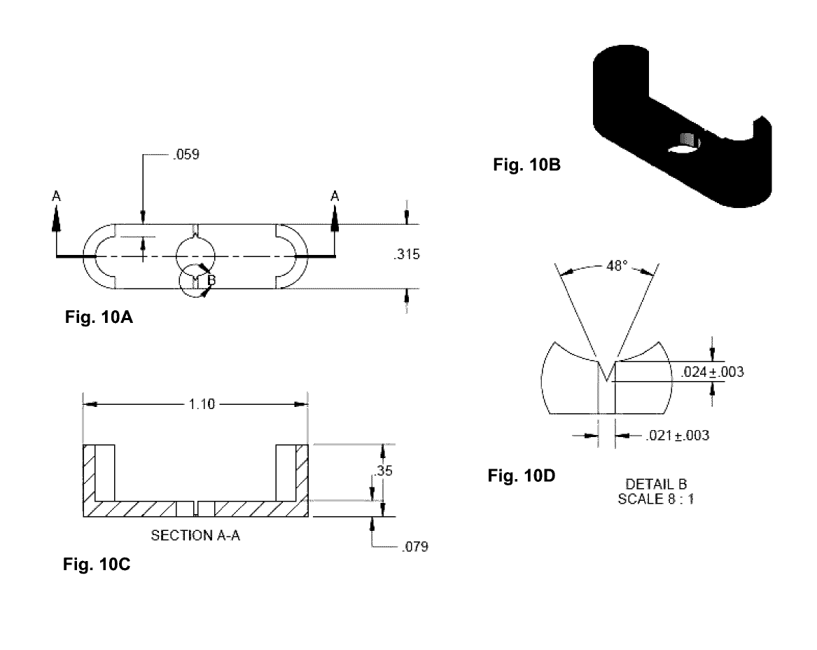

Preferably, the conduit comprises a longitudinal slit (see for example FIG. 1 #5), preferably in the form of a “v-groove” (see for example, FIGS. 8A, 8B and 10D) defined in the peripheral wall of the conduit to enable the nasogastric tube to be moved out of the passageway defined by the conduit and separate the guide from the nasogastric tube. The purpose of this is to allow removal of the device from the subject without disturbing the nasogastric tube. The slit may be sealed in some way to prevent the nasogastric tube from inadvertently becoming dislodged from the device during the insertion and location procedure. Preferably, the longitudinal slit comprises a tear-away mechanism to allow removal of the introducer once the NGT has passed through its hollow conduit into the esophagus (FIGS. 8A, 8B; 10D). In a preferred embodiment the handle is configured to help the user insert and peel the guide with ease (FIGS. 10A, 10B, 10C and 10D). It preferably has a curved design that allows placement of a thumb on either side to initiate the tearing of the guide to release it from the NGT. The skilled person would understand that other means for removing the device while leaving the nasogastric tube undisturbed in situ may be possible without deviating from the present invention.

The conduit of the nasogastric tube introducer device may also comprise guide and/or depth markings (FIG. 1 #9) and/or a reflective longitudinal line (FIG. 1; #3). These markings assist the user to determine the position of the device within the nasal cavity, throat and esophagus during the insertion procedure. A reflective longitudinal line may help orientate the user as to which side should be facing upwards or downwards during the insertion. Preferably the conduit is configured in shape and length so that its distal end is advanced to its position of intended use in the hypopharynx just above the cricopharyngeus muscle and enter the esophagus, to allow the NGT to be passed into the esophagus and reach the stomach.

In a preferred embodiment, the device is manufactured using extrusion methods and the device is comprised of the following materials obtainable from NuSil Technology LLC, CA 93013 USA and Parylene Coatings Services, Inc, Texas 77494 USA: Material for the Guide: MED-4080 HCR (Durometer, Type A 80, ASTM D2240); Material for the distal tip: MED-4930 (Durometer, Type A 30, ASTM D2240); Material for the handle: MED-4950 LSR (Durometer, Type A 50, ASTM D2240); Material for the Over mold: MED-4950 LSR (Durometer, Type A 50, ASTM D2240);
Coating of inner surface: MED 6670 (Durometer, Type A 70, ASTM D2240);
Coating of outer surface: MED 6670/Parylene.

An advantage of the present invention is that nurses would be incentivized to adopt this product because they could overcome the practical difficulties faced during insertion of nasogastric tubes, like coiling and poor maneuverability etc., hence saving precious time. The present invention is suitable for stroke patients, elderly and the disabled with difficulty in swallowing. It should be best deployed in an inpatient setting, community hospitals or nursing homes.

### EXAMPLES

Nasogastric Tube Introducer Device Manufacture

The nasogastric tube introducer device of the invention may be manufactured by 3D printing or by extrusion methods.

Extrusion

In a preferred embodiment of the invention, the nasogastric tube introducer device is made from silicone by extrusion.

The silicone extrusion process begins with blending a two-part silicone gumstock on a two-roll mill to produce a homogeneous medical-grade silicone. The silicone was then formed into strips and fed continuously into the extruder. Once the required shape was acheived the medical grade tubing was passed through an oven to cure the product with radiant heat.

For the device described herein a “form fixture” and “over molds” were developed to form and mold components. Also, the soft tip was made as a separate mold and then fused together.

Suitable silicone material for the guide may be MED-4080 HCR (high consistency rubber) (NuSil Technology LLC, CA 93013 USA) a two-part, high durometer (Type A 80, ASTM D2240), tear resistant silicone elastomer.

Suitable material for the Over mold and/or handle may be MED-4950 LSR (liquid silicone rubber) (NuSil Technology LLC, CA 93013 USA), a two-part, translucent silicone system (Durometer, Type A 50, ASTM D2240) used with injection molding equipment.

The inner surface of the silicone guide may be coated to decrease the coefficient of friction (CoF) compared to the uncoated silicone and increase abrasion resistance. A suitable coating for the inner surface of the invention may be MED 6670 (NuSil Technology LLC, CA 93013 USA), a two-part silicone elastomer (Durometer, Type A 70, ASTM D2240) dispersed in xylene.

The outer surface of the guide may also be coated with a protective polymeric substance. A suitable outer coating is known as Parylene (Parylene Coatings Services, Inc, Texas 77494 USA). A more preferred outer coating comprises a mixture of Parylene and MED 6670.

TABLE 1
Results of manikin testing of 3D printed devices

| Bench Tests | Results | Conclusions |
|---|---|---|
| Curvature test of | Fail: Both manikins— | Further test on |
| Six 3DP guides | not physiologically | Manikin Gaumard |
| (Curve A & B) | compatible | Hal S3201 |
| on manikin Siman | | |
| 3G & Laerdal | | |
| half-body manikin | | |
| Curvature test of Six | Fail: Curve B not | Effective |
| 3DP guides (Curve A | anatomically- | manoeuvrability of |
| & B) on manikin | conforming & traumatic | guide with Curve A |
| Gaumard Hal S3201 | Pass: Distal tip of Curve | |
| | A enter esophagus | |
| BAAM whistle | Pass: Need 2 cm H₂O of | Whistle is suitable |
| sensitivity test on | air pressure to whistle | |
| manikin S3201 | Inhalation—short beep | |
| | Exhalation—long whistle | |
| No bevel tip test on | Fail: No whistle sound | Bevel tip is |
| in-vitro respiratory | as no air gets | required |
| silicone model | into the guide | |
| Curvature test of 3DP | Pass: Distal tip | Further bench tests |
| guides on cadaver | enter esophagus | of extruded guides |
| | | on manikin |
| | | & cadaver |

3DP: 3D printed.

Current Technologies and Shortcomings

Bedside clinical tests like the “Whoosh test” and pH test have long been established to be inadequate for placement confirmation [Farrington M., et al., Pediatr Nurs 35(1): 17-24 (2009)]. The CXR is at present the most routinely used method to confirm placement inpatient, usually in combination with the previous tests. However, incidence of misplacement remains at 3.2%, and reported deaths resulting from missed airway intubation are at 0.5% [de Aguilar-Nascimento, J. E. & Kudsk, K. A. JPEN J Parenter Enteral Nutr 31: 269-273 (2007)].

Colorimetry (Rightspot) has not been formally trialled for safety and carries the risk of false negatives due to concurrent acid secretion or inability to aspirate gastric contents (e.g. on an empty stomach, or a tube's exit holes are against the stomach wall)

Electromagnetic-guided placement (CorTrak) is claimed to provide bedside direct visualization during NGT insertion, but it is costly and studies document success rates of only 80%. In addition there have been 21 adverse events reported to the US FDA Manufacturer and User Facility Device Experience (MAUDE) database.

(Conventional) endoscopic placement of NGTs allows direct visualization of the NGT in the esophagus but is costly, time-consuming and requires the expertise of a trained specialist. This method is reserved for patients with distorted anatomy, for example, by obstruction from a tumour.

The IRIS system is essentially the same as endoscopic NGT placement without the steerability of an endoscope and shares the same problems of cost, time and requirement of specialist presence.

Capnography (CO2nfirm) claims to provide immediate feedback but remains a somewhat costly option and also does not reliably rule out airway intubation [Melody Ni et al., EMJ Gastroenterol 3: 49-56 (2014)].

The benefits or advantages of the present invention over other currently known methods were determined in a comparative study and are set out in Table 2.

TABLE 2
Comparison of invention (Soprano) with known methods.

| | | | | | Electro- | Endo- | Capno- |
|---|---|---|---|---|---|---|---|
| Device/Method | | | CXR/ | Colorimetry | magnetic | scopic | graphy |
| Advantages | Soprano | Auscultation | pH | (Rightspot) | (CorTrak) | (IRIS) | (CO₂nfirm |
| Mitigates airway | +++ | + | ++ | ++ | ++ | +++ | ++ |
| intubation | | | | | | | |
| Time-efficient | ++ | +++ | ++ | ++ | ++ | + | ++ |
| Cost-effective | ++ | +++ | ++ | ++ | − | − | ++ |
| Easy to learn | ++ | +++ | ++ | ++ | + | −− | ++ |
| Evidence Based | +++ | + | ++ | + | ? | ? | ? |

Bibliography

Benya, R., Langer, S. and Mobarhan, S. Flexible nasogastric feeding tube tip malposition immediately after placement. JPEN J Parenter Enteral Nutr 14(1): 108-9 (1990).

Coombes, R. NHS safety agency issues guidance on nasogastric tubes. Brit Med J 330(7489): 438 (2005).

de Aguilar-Nascimento, J. E. and Kudsk, K. A. Use of small-bore feeding tubes: successes and failures. Curr Opin Clin Nutr Metab Care 10(3): 291-6 (2007).

de Aguilar-Nascimento, J. E. and Kudsk, K. A. Clinical costs of feeding tube placement. JPEN J Parenter Enteral Nutr 31: 269-273 (2007). /

Farrington, M., Cullen L. and Stewart, S. Nasogastric Tube Placement Verification in Pediatric and Neonatal Patients. Pediatr Nurs 35(1): 17-24 (2009).

Grand View Research, Enteral Feeding Devices Market Analysis By Product (Giving Sets, Enteral Feeding Pumps, Gastrostomy Tubes, Low Profile Gastrostomy Devices, Percutaneous Endoscopic Gastrostomy Devices And Nasogastric Tubes) And Segment Forecasts To 2020, www.grandviewresearch.com/industry-analysis/enteral-feeding-devices-industry.

Krenitsky, J. Blind Bedside Placement of FeediNGTs: Treatment or Threat? Practical Gastroenterology 93: 11 (2011).

Metheny, N. A., Meert, K. L. and Clouse, R. E. Complications related to feeding tube placement. Curr Opin Gastroenterol 23: 178-182 (2007).

Ni, M. et al., Risks of using bedside tests to verify nasogastric tube position in adult patients. EMJ Gastroenterol 3: 49-56 (2014).

1. A nasogastric tube introducer device comprising guide means in order to guide the nasogastric tube into a subject, the guide means comprising a semi-rigid longitudinal conduit having a peripheral wall defining a passageway therethrough extending from a first/proximal end to a second/distal end, wherein the conduit is curvilinear comprising a curvature that conforms to the anatomy of the nasopharynx area and wherein the curvature improves steering of the nasogastric tube towards the gastrointestinal tract, wherein the second/distal end is curved with a posterior bias to reduce the likelihood of cannulation of the trachea, wherein the conduit has a handle at the first end and wherein the conduit comprises a longitudinal slit defined in the peripheral wall of the conduit to enable the conduit to be split and separated from the nasogastric tube, thereby leaving the nasogastric tube in place.

2. The nasogastric tube introducer device of claim 1, wherein the conduit has an elliptical cross-sectional profile.

3. The nasogastric tube introducer device of claim 1, wherein the semi-rigid material is silicone.

4. The nasogastric tube introducer device of claim 1, wherein the tip of the second/distal end is comprised of a compliant material to minimise mucosal injury.

5. The nasogastric tube introducer device of claim 1, wherein the tip of the second/distal end is bevelled.

6. The nasogastric tube introducer device of claim 1, wherein the tip of the second/distal end is comprised of silicone.

7. The nasogastric tube introducer device of claim 1, further comprising an alarm member mounted thereto at the first/proximal end that detects air passing through the trachea and provides an indication whether the nasogastric tube is correctly positioned in the gastrointestinal tract or is misplaced in the lung of said subject

8. The nasogastric tube introducer device of claim 7, wherein the alarm member is whistle-like and produces a distinct sound corresponding to the bidirectional airflow in the trachea of the subject; wherein an audible signal indicates tracheal cannulation and correct placement in the esophagus does not produce the audible signal.

9. The nasogastric tube introducer device of claim 1, wherein the longitudinal slit comprises a tear-away slit.

10. The nasogastric tube introducer device of claim 1, wherein the conduit comprises guide and depth markings.

11. The nasogastric tube introducer device of claim 1, wherein the conduit is configured so that its distal end is advanced to its position of intended use in the hypopharynx just above the cricopharyngeus.

12. The nasogastric tube introducer device of claim 1, manufactured from silicone and wherein the conduit has an elliptical cross-sectional profile, has a bevelled tip at the distal end comprised of a compliant material to prevent mucosal injury and comprises a tear-away slit.

13. The nasogastric tube introducer device of claim 1, wherein the device is made from silicone and the silicone for the guide means is MED-4080 HCR (high consistency rubber, durometer Type A 80, ASTM D2240) or the equivalent thereof; the silicone for the distal tip is MED-4930 (durometer Type A 30, ASTM D2240) or the equivalent thereof; the silicone for the handle is MED-4950 LSR (liquid silicone rubber, durometer Type A 50, ASTM D2240) or the equivalent thereof; the inner surface is coated with silicone MED-6670 (durometer Type A 70, ASTM D2240) or the equivalent thereof and the outer surface is coated with MED 6670/Parylene or the equivalent thereof.

14. Use of the nasogastric tube introducer device of claim 1 to insert a nasogastric tube through the nose and into the stomach of a patient.
